(19) United States
(12) Patent Application Publication
(10) Pub. No.: US 2008/0177991 A1
(43) Pub. Date: Jul. 24, 2008

(54) METHOD AND DEVICE FOR IMPROVING DEBUG TIME OF A DISPLAY APPARATUS

(75) Inventors: Ming-Chang Liu, Changhua County (TW); Kuo-Chi Chen, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/737,767

(22) Filed: Apr. 20, 2007

(30) Foreign Application Priority Data
Jan. 19, 2007 (TW) 96102040

(51) Int. Cl. G06F 9/44

(52) U.S. Cl. 712/227; 712/E09.006

(57) ABSTRACT

A method and a device for improving debug time of a display apparatus are provided. The display apparatus includes an input signal connector for receiving an external input signal, an MCU, a bus and a plurality of units. The input signal connector is connected to the MCU via the bus, and the MCU is connected to the plurality of units via the bus. First, whether the MCU has entered the debug mode is detected; and when it is detected that the MCU has entered the debug mode, the bus switches to directly connect to the plurality of units in the display apparatus for allowing the external signal transmitted directly to the plurality of units for debugging.

### CROSS-REFERENCE TO RELATED APPLICATION

This application claims the priority benefit of Taiwan application serial no. 96102040, filed Jan. 19, 2007. All disclosure of the Taiwan application is incorporated herein by reference.

### BACKGROUND OF THE INVENTION

1. Field of the Invention

The present invention generally relates to a debug method and a device for a display apparatus, and more particularly to a method and a device for improving debug time of a display apparatus.

2. Description of Related Art

Generally, during fabrication, assembling, or burn-in test of various displays, failures often occur. However, at this stage, since the display has already be installed, the housing thereof has to be taken off in order to find out the true reason that causes the problem. Unfortunately, the phenomenon of failure is often not likely to be favourably simulated, which often delays production or testing plan thereof.

Generally, a display includes at least one externally exposed connection port for receiving input signals. The connection port for example can be an analogy video interface (D-Sub), a digital video interface (DVI), or a high definition multimedia interface (HDMI). As shown in FIG. 1, some displays include non-integrated chip built internally, while some others, as shown in FIG. 2, include integrated chips. When the assembly of the display has been completed, the externally exposed connection port is the only approach to conduct a debug operation without taking off the housing. Some uses unused pins incorporated with wires developed by themselves to debug. However, this would increase cost due to need of extra wires. Further, because the wires employed are non-standard, they cannot be easily purchased from market. Furthermore, such an approach is not feasible when there is no unused pin of the externally exposed connection port available.

FIG. 1 is a block diagram illustrating a conventional debug device of a display apparatus having a non-integrated chip. Referring to FIG. 1, the debug device includes an input signal connector 100, a micro controller unit (MCU) 110, a plurality of units 120_1 through 120_{—}n. The input signal connector 100 is adapted for receiving an external input signal, and the MCU 110 is coupled to the input signal connector 100 via a bus for receiving the external input signal. The plurality of units 120_1 through 120_{—}n are controlled by the MCU 110, and are adapted for performing different functions. The MCU 110 and the units 120_1 through 120_{—}n are coupled via the bus. The bus complies with IIC protocol and has a pair of bi-direction transmitting lines (a serial data line L1_1 and a serial clock signal line L2_1). The MCU 110 has an MCU interface 130 for receiving an input signal from an external IIC bus and processing the input signal to determine whether the MCU 110 needs to send a control signal to the units 120_1 through 120_{—}n of the next layer via the IIC bus.

FIG. 2 is a block diagram illustrating a conventional debug device of a display apparatus having an integrated chip. The only difference of FIG. 2 from FIG. 1 is that the MCU 110 of FIG. 1 is integrated to an integrated chip 210, while symbols of the other elements and the operation methods are same as that of FIG. 1.

Further, another approach to debug is to employ an MCU having a display data channel command interface (DDC/CI). However, a DDC/CI command program must be written into the MCU and the DDC/CI command must be written into a debug tool for incorporation before using this approach. This approach requires larger MCU program space, and the debug program being amended thereby, which is inconvenient to use.

FIG. 5 is a block diagram illustrating a debug method of FIGS. 1 and 2. When performing a debug mode with a DDC/CI command, as shown in FIG. 5, all reading/writing control processes between the debug tool 500 and its next layer IIC units 520_1 through 520_{—}n must flow through a MCU 510 via the IIC bus, so that the next layer IIC units 520_1 through 520_{—}n are commanded to read/write. As such, more IIC units 520_{—}a through 520_{—}n require more reserved program space, and thus increase the production cost.

### SUMMARY OF THE INVENTION

Accordingly, the present invention is directed to a method and a device for improving debug time of a display apparatus, which are adapted for increasing reading/writing speed and reducing the cost.

The present invention provides a debug method for a display apparatus. The display apparatus includes an input signal connector for receiving an external input signal. The input signal connector is connected to a micro control unit (MCU) of the display apparatus via a bus. The MCU is coupled to a plurality of units in the display apparatus via the bus. The debug method of the display apparatus includes detecting whether the MCU enters a debug mode. After the MCU enters the debug mode, the bus switches to directly connect to the plurality of units in the display apparatus for allowing the external signal transmitted directly to the plurality of units for debugging.

The present invention further provides a display apparatus having a built-in debug function. The display apparatus includes an input signal connector, an MCU, a plurality of units and a switch. The input signal connector is adapted for receiving an external input signal. The MCU is coupled to the input signal connector via a bus for receiving the external input signal. The plurality of units are controlled by the MCU, and have various different functions. The MCU is coupled to the plurality of units via the bus. The switch is disposed between the input signal connector and the plurality of units, and is adapted for switching the controlled connections thereof. When the MCU is detected to enter a debug mode, the switch switches the bus to directly connect to the plurality of units, so as to allow the external signal to directly transmit a control signal complying with a protocol of the bus for debugging.

The present invention is directed to a switch, such that when entering the debug mode, the MCU outputs a signal to command the switch to switch to directly connect the input signal connector and the units via the IIC bus. Therefore, the debug process would not be processed by the MCU. As such, states between the units can be judged at once, and failures can be found by directly debugging without requiring taking off the housing and shutting off the power supply, thus saving time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a conventional debug device of a display apparatus having a non-integrated chip.

FIG. 2 is a block diagram illustrating a conventional debug device of a display apparatus having an integrated chip.

FIG. 3 is block diagram illustrating a device for improving debug time of a display apparatus having a non-integrated chip according to an embodiment of the present invention.

FIG. 4 is block diagram illustrating a device for improving debug time of a display apparatus having an integrated chip according to an embodiment of the present invention.

FIG. 5 is a block diagram illustrating a debug method of the convention debug device in FIGS. 1 and 2.

FIG. 6 is a block diagram illustrating a debug method of the device in FIGS. 3 and 4.

FIG. 7 is a block diagram illustrating detection of whether or not the MCU has entered a debug mode.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

As discussed above, in the aforementioned conventional debug method for display apparatus, reading/writing control operations between the debug tool and the devices must be transmitted via the MCU and sent from the MCU to control the IIC devices to read/write. However, more devices controlled by the MCU require more program space reserved in the MCU, thus increasing the production cost. Accordingly, with respect to the foregoing shortcomings, the present invention provides a method without adding much program space of the MCU and/or amending the debug tool program. The method includes employing an external switch for switching DDC IIC channel to an ordinary IIC bus under a debug mode and controlling reading/writing functions of each IIC devices respectively. Since the reading/writing operations do not flow through the MCU, the speed thereof is thus increased. The present invention may be illustrated in details as follows.

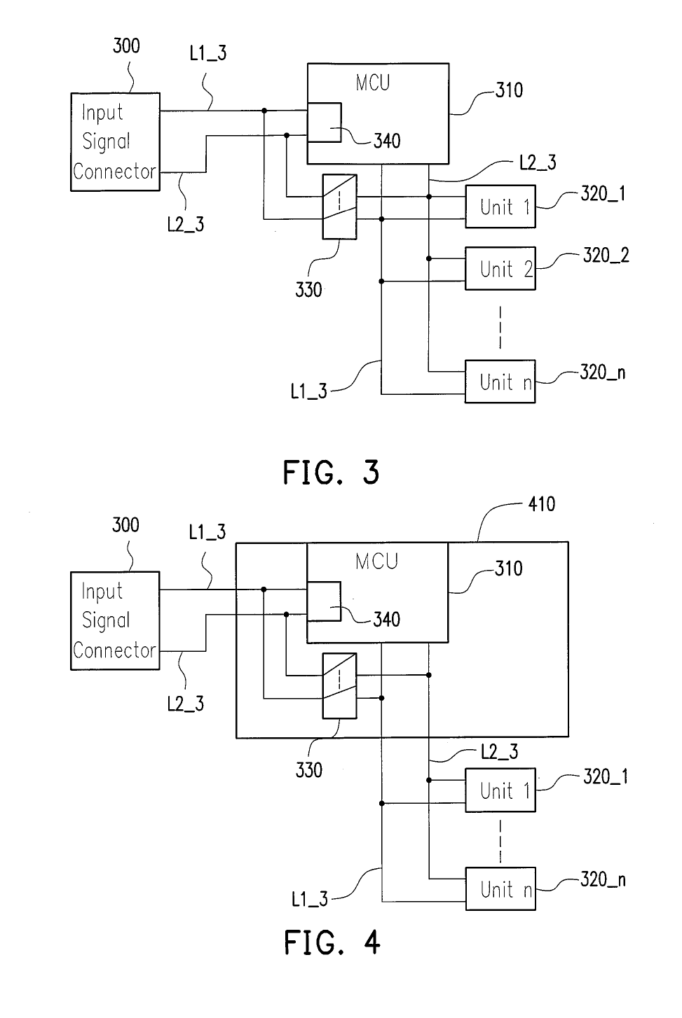

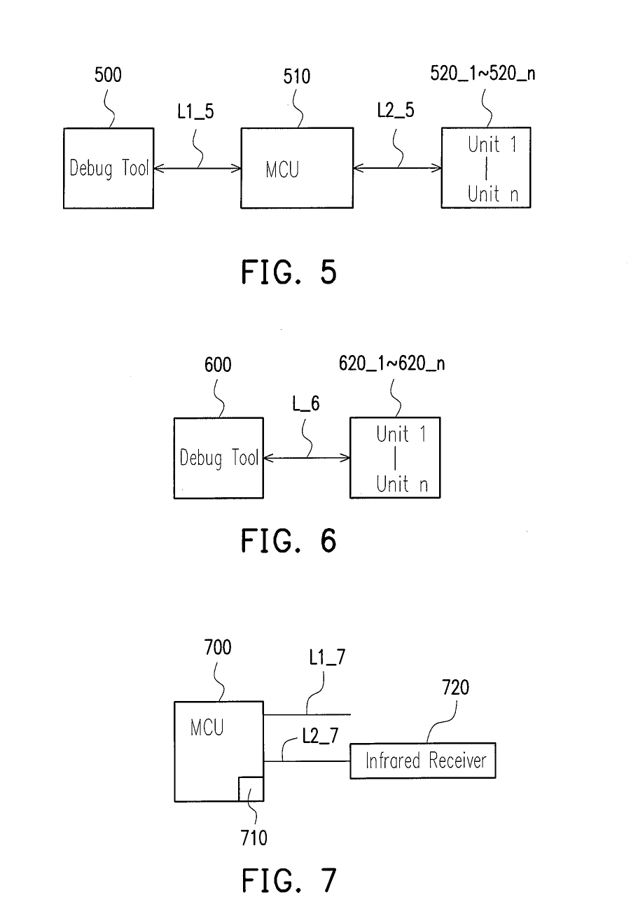

FIG. 3 is block diagram illustrating a device for improving debug time of a display apparatus having a non-integrated chip according to an embodiment of the present invention. The device includes an input signal connector 300, an MCU 310, a plurality of units 320_1 through 320_{—}n, and a switch 330. The input signal connector 300 is adapted for receiving an external input signal. The MCU 310 is coupled to the input signal connector 300 via a bus for receiving the external input signal. The plurality of units 320_1 through 320_{—}n are controlled by the MCU 310, and have different functions. The MCU 310 is coupled to the units 320_1 through 320_{—}n via the bus. The switch 330 is disposed between the input signal connector 300 and the units 320_1 through 320_{—}n, for controlling connections via the switch 330. The bus complies with an IIC protocol and has a pair of bi-direction transmitting lines (a serial data line L1_3 and a serial clock signal line L2_3). When an MCU interface 340 receives an input signal from an external bus, and detects that the MCU 310 entered a debug mode, the MCU 310 outputs a signal to command the switch 330 to switch the bus to directly connect to the units 320_1 through 320_{—}n in the display apparatus. In this way, the external input signal transmits a control signal complying with the bus protocol to the units 320_1 through 320_{—}n for debugging.

FIG. 4 is block diagram illustrating a device for improving debug time of a display apparatus having an integrated chip according to an embodiment of the present invention. Referring to FIG. 4, it is shown that the switch 330 of FIG. 3 is integrated to an integrated chip 410, wherein the line layout is specifically designed so that connections between the input signal connector 400 and the units 420_1 through 420_{—}n are controlled by the switch 330, so as to allow the external signal complying with the bus protocol to directly transmit a control signal to the units 420_1 through 420_{—}n. Such a device not only reduces the occupation of external layout space, but also saves production cost by employing the switch.

FIG. 6 is a block diagram illustrating a debug method of the device in FIGS. 3 and 4. As clearly shown in FIG. 6, the debug tool 600 is directly connected to the units 620_1 through 620_{—}n via the IIC bus. As such, only when the MCU enters the debug mode, all reading/writing operations between the debug tool 600 and the units 620_1 through 620_{—}n do not flow through the MCU, so that the reading/writing speed thereof can be effectively promoted, and the cost can be correspondingly reduced.

FIG. 7 is a block diagram illustrating detection of whether or not the MCU has entered a debug mode. Different aspects of the embodiment according to the present invention are provided for detecting whether the MCU has entered the debug mode. According to one aspect, it can be judged by detecting a state of a single I/O port L1_7 or L2_7 in the MCU 700. According to another aspect, it can also be judged by detecting states of a multiple of I/O ports L1_7 and L2_7 in the MCU 700. According to a further aspect, it can be judged by employing an infrared receiver 720 for receiving the detected states of the I/O ports L1_1, or L2_7, or both of L1_7 and L2_7. The states of the foregoing I/O ports L1_1, L2_7 can be defined according to the application requirement. For example, when detecting a state of a single I/O port L1_7 or L2_7, it can be defined as “High” or “Low”, or even a specific voltage level. Likewise, there are more alternations when detecting states of a multiple of I/O ports L1_7 and L2_7. However, regardless of the foregoing aspects in use, only when the MCU 700 enters the debug mode, the states of the I/O ports L1_7 and/or L2_7 will be recorded in a flag register 710 inside the MCU 700, so that it will leave the debug mode when the display apparatus is restarted after being turned off. It is to be noted that besides the aforementioned approaches, an on screen display (OSD) menu can also be used for selecting whether to enter the debug mode.

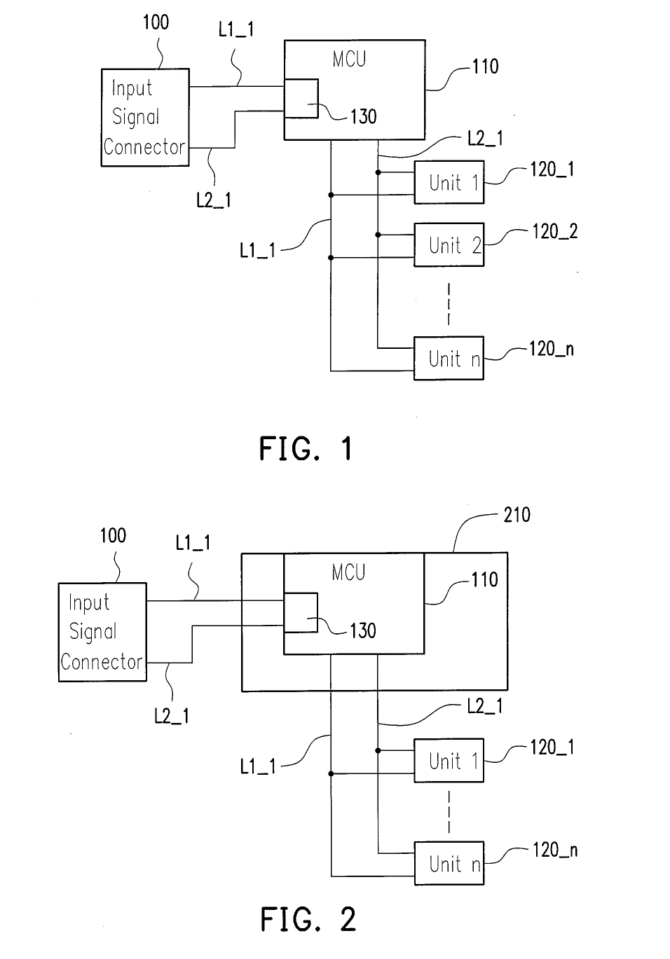

The present invention as shown in FIG. 3 is featured as employing a switch 330 in addition to the conventional circuit of FIG. 1. When the MCU 310 enters the debug mode, the switch 330 switches to directly connect the input signal connector 300 to the units 320_1 through 320_{—}n with the IIC bus, which is similar to that shown in FIG. 6, that is the debug tool 600 and the units 600_1 through 600_{—}n are directly connected by the IIC bus L_6. At this time, the states of the units 600_1 through 600_{—}n can be promptly judged without involving the MCU therein. As such, the failure can be directly found without taking off the housing of the display apparatus and/or shutting off the power supply, so as to reduce debug time. Further, the switch 330 of FIG. 3 according to an embodiment of the present invention is integrated to an integrated chip 410 as shown in FIG. 4, which saves external space, and production cost thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A debug method for a display apparatus, the display apparatus comprising an input signal connector for receiving an external input signal, an MCU, a bus, and a plurality of units, wherein the input signal connector is connected to the MCU via the bus, and the MCU is connected to the plurality of units via the bus, the debug method comprising:
detecting whether the MCU has entered the debug mode; and
switching to directly connecting to the plurality of units in the display apparatus for allowing the external signal transmitted directly to the plurality of units for debugging when the MCU enters the debug mode.

2. The debug method according to claim 1, wherein the bus has a pair of bi-directional transmitting lines comprising a serial data line and a serial clock signal line.

3. The debug method according to claim 2, wherein the bus complies with an IIC protocol.

4. The debug method according to claim 1, wherein whether the MCU has entered the debug mode is detected by detecting a state of a single I/O port in the MCU.

5. The debug method according to claim 4, wherein whether the MCU has entered the debug mode is judged according to the state of the I/O port in the MCU being at a high logic voltage level or a low logic voltage level.

6. The debug method according to claim 4, wherein the MCU comprises:
a flag register, wherein when the MCU enters the debug mode, states of the I/O ports will be recorded in the flag register.

7. The debug method according to claim 1, wherein whether the MCU has entered the debug mode is detected by detecting combinations of states of a multiple of I/O ports in the MCU.

8. The debug method according to claim 7, wherein whether the MCU has entered the debug mode is judged according to combinations of states of the I/O ports in the MCU, wherein each of which can be a high logic voltage level or a low logic voltage level.

9. The debug method according to claim 1, wherein whether the MCU has entered the debug mode is detected by selecting an OSD menu presented on a screen of the display apparatus.

10. A display apparatus having a built-in debug function, comprising:
an input signal connector, for receiving an external input signal;
an MCU, coupled to the input signal connector via a bus for receiving the external input signal;
a plurality of units, controlled by the MCU, comprising different functions, wherein the MCU is coupled to the units via the bus; and
a switch, disposed between the input signal connector and the units, for switching the controlled connections thereof,
wherein when it is detected that the MCU has entered a debug mode, the switch switches the bus to directly connect to the plurality of units so as to allow the external signal to directly transmit a control signal complying with a protocol of the bus for debugging.

11. The display apparatus according to claim 10, wherein the bus has a pair of bi-directional transmitting lines comprising a serial data line and a serial clock signal line.

12. The display apparatus according to claim 11, wherein the bus complies with an IIC protocol.

13. The display apparatus according to claim 10, wherein whether the MCU has entered the debug mode is detected by detecting a state of a single I/O port in the MCU.

14. The display apparatus according to claim 13, wherein whether the MCU has entered the debug mode is judged according to the state of the I/O port in the MCU being at a high logic voltage level or a low logic voltage level.

15. The display apparatus according to claim 13, wherein the MCU comprises:
a flag register, wherein when the MCU enters the debug mode, states of the I/O ports will be recorded in the flag register.

16. The display apparatus according to claim 10, wherein whether the MCU has entered the debug mode is detected by detecting combinations of states of a multiple of I/O ports in the MCU.

17. The display apparatus according to claim 16, wherein whether the MCU has entered the debug mode is judged according to combinations of states of the I/O ports in the MCU, wherein each of which can be a high logic voltage level or a low logic voltage level.

18. The display apparatus according to claim 16, wherein the MCU comprises:
a flag register, wherein when the MCU enters the debug mode, states of the I/O ports will be recorded in the flag register.

19. The debug method according to claim 10, wherein whether the MCU has entered the debug mode is detected by selecting an OSD menu presented on a screen of the display apparatus.

20. The debug method according to claim 10, wherein the switch is integrated inside the MCU such that connections between the input signal connector and the units are controlled by the switch via a line layout, so as to allow the external input signal complying with a bus protocol to directly transmit a control signal to the units.
